(19) United States
(12) Patent Application Publication
(10) Pub. No.: US 2024/0024971 A1
(43) Pub. Date: Jan. 25, 2024

(54) GAP CUTTING DOUBLE BLADE RECIPROCATING SAW ATTACHMENT

(71) Applicant: Russell Harris Walker, Oakdale, NY (US)

(72) Inventor: Russell Harris Walker, Oakdale, NY (US)

(21) Appl. No.: 17/813,628

(22) Filed: Jul. 20, 2022

(51) Int. Cl. B23D 49/10

(52) U.S. Cl. CPC B23D 49/10

(57) ABSTRACT

A saw blade for a reciprocating saw, a reciprocating saw and blade, and a method for making a slotted cut of uniform spacing along a length of the cut are disclosed. A pair of blades, each at an off set from the reciprocating axis, the saw blades can make the slotted cut in a substrate with a single pass of the reciprocating saw. In some embodiments, the saw blade includes at least one blade is mounted to an adapter at an offset from a reciprocating axis of the reciprocating saw. The offset of the blades may be adjustable to obtain a slotted cut of a uniform width.

### BACKGROUND OF THE INVENTION

The present invention relates to saw blades, and more particularly to saw blades for cutting a slot in a substrate.

In many types of construction installations, such as recessed lighting, Pittcon/reveal bead, building control/expansion joint installations, it is desirable to cut a slotted opening. For these installations the installer needs to cut parallel lines of uniform spacing along a length of the installation. Presently, this is performed by making a first cut along a desired line, then making a second cut at the desired uniform spacing in parallel with the first cut.

Other tools for slot cutting include a Dato notching saw that includes a vacuum attachment. This tool is bulky and generally requires the use of a straight edge to run the tool along the length of the substrate to make the slotted cut.

Each alternative is either cost prohibitive or inefficient, particularly for long expanses requiring a slotted cut.

As can be seen, there is a need for improved apparatus and methods for making a slotted cut.

### SUMMARY OF THE INVENTION

In one aspect of the present invention, a saw blade for a reciprocating saw is disclosed. The saw blade includes an adapter having a proximal end and a distal end. A coupling at the proximal end of the adapter is dimensioned to couple the adapter to a reciprocating shaft of the reciprocating saw. At least one saw blade operatively attached to the distal end of the adapter at a lateral offset dimension from a reciprocating axis of the reciprocating shaft.

In some embodiments, the at least one saw blade is adjustably attached to the adapter for a selectable lateral offset dimension.

In some embodiments, the at least one saw blade includes a pair of blades operatively attached to the adapter in a desired lateral spacing. The pair of blades are configured for cutting a slot in a substrate having a width of the desired lateral spacing.

In some embodiments, the pair of blades are disposed on opposed sides of the adapter.

In some embodiments, the saw blade includes a projection extending from the proximal end of the adapter and an interface hole adapted to engage with a retaining pin of the reciprocating saw.

In some embodiments a first aperture and a second aperture are defined in a spaced apart relation along the distal end of the adapter. A first hole is defined at a shank of the at least one saw blade and a second hole is defined at an intermediate position of the saw blade. A first threaded fastener extends through the first aperture and the first hole. A second threaded fastener extends through the second aperture and the second hole. A nut secures with each of the first threaded fastener and the second threaded fastener to retain the at least one saw blade with the adapter.

In some embodiments, a washer is interposed on each of the first threaded fastener and the second threaded fastener to adjustably attach the at least one saw blade at a desired lateral offset dimension.

In some embodiments, the at least one saw blade includes a pair of saw blades operatively attached to the adapter in a desired lateral spacing. The pair of saw blades is configured for cutting a slot in a substrate having a width of the desired lateral offset.

In some embodiments, the pair of saw blades are adjustably attached to the adapter.

In other aspects of the invention, a reciprocating saw is disclosed. The reciprocating saw includes a reciprocating shaft. An adapter is removably coupled with the reciprocating shaft. At least one saw blade is removably coupled with the adapter at a desired lateral offset from a reciprocating axis of the reciprocating shaft.

In some embodiments, the at least one saw blade includes a pair of saw blades removably coupled on opposed sides of the adapter.

These and other features, aspects and advantages of the present invention will become better understood with reference to the following drawings, description and claims.

### BRIEF DESCRIPTION OF THE DRAWINGS

FIG. 1 is a perspective view of the invention in use;

FIG. 2 is a perspective view of the invention;

FIG. 3 is an exploded view of the invention;

FIG. 4 is a top view of the invention;

FIG. 5 is a section view of the invention, taken along line 5-5 in FIG. 4;

FIG. 6 is a perspective view of an alternate embodiment of the invention;

FIG. 7 is an exploded view of an alternate embodiment of the invention; and

FIG. 8 is a section view of the alternate embodiment of the invention, taken along line 8-8 in FIG. 6.

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention.

Broadly, embodiments of the present invention provide a saw blade for a reciprocating saw, a reciprocating saw and blade, and a method for making a slotted cut of uniform spacing along a length of the cut. The saw blade includes at least one blade mounted to an adapter at an offset from a reciprocating axis of the reciprocating saw. With a pair of blades, each at an offset from the reciprocating axis, the saw blade can make the slotted cut in a substrate with a single pass of the reciprocating saw.

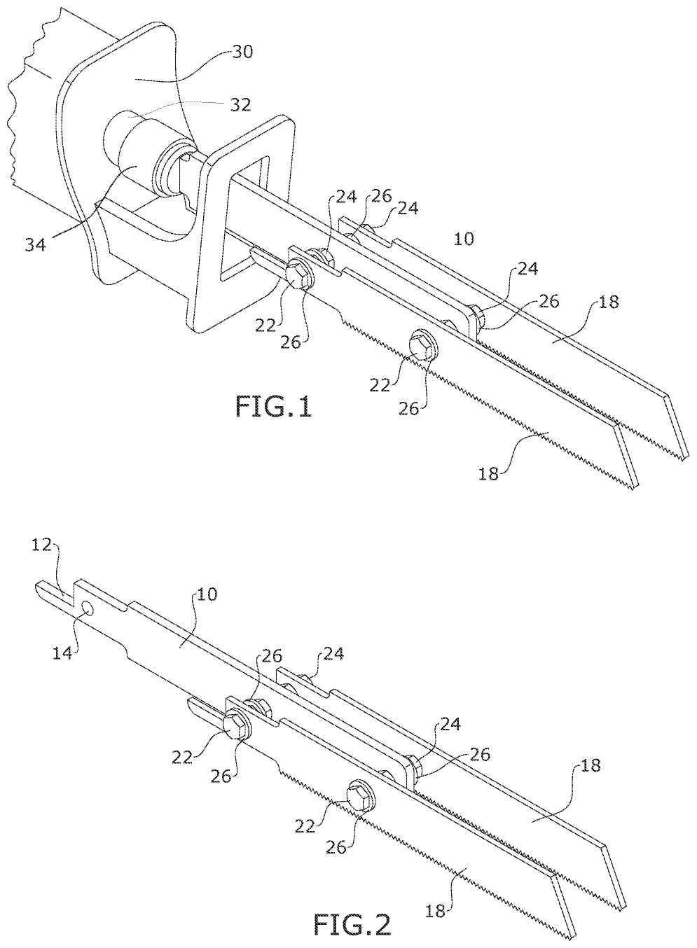

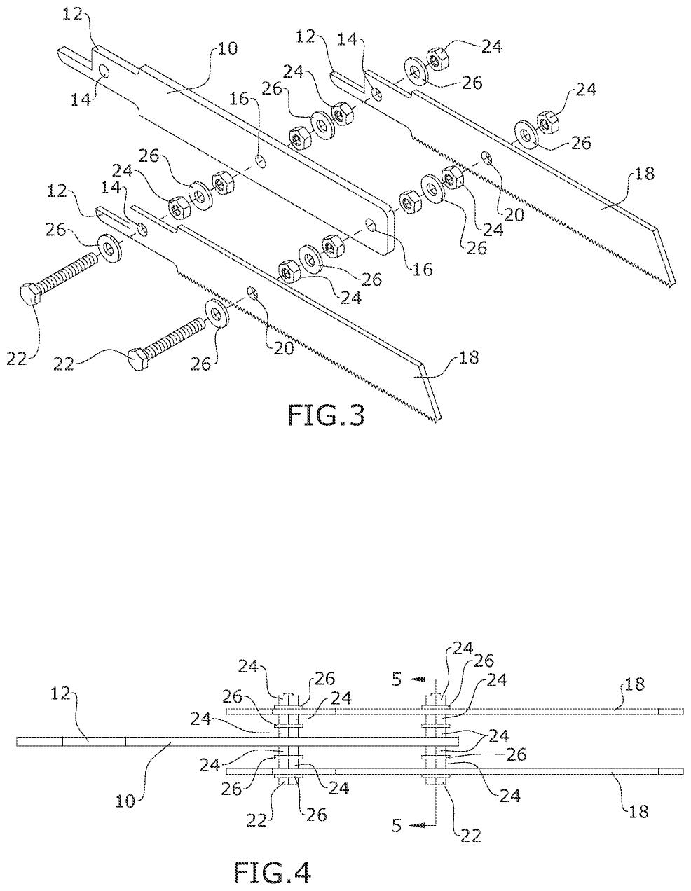

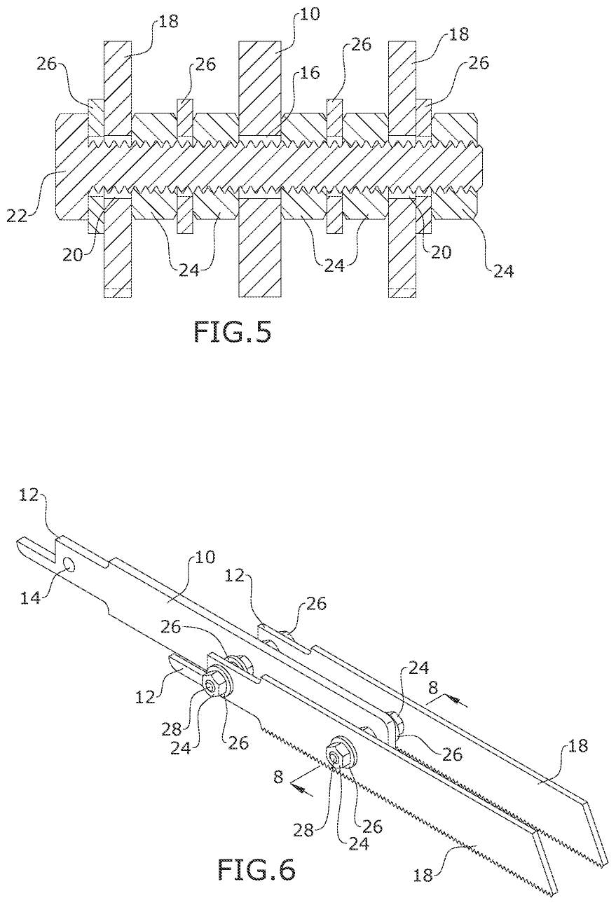

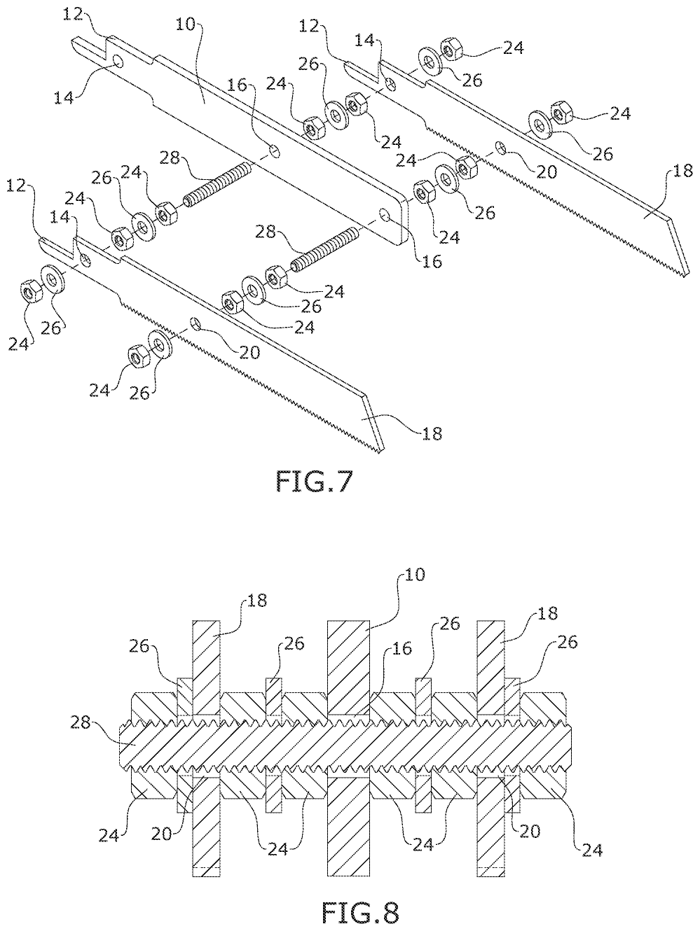

Non-limiting embodiments of a saw blade of the present invention are shown in reference to the drawings of FIGS. 1-8. The saw blade includes an adaptor 10 having a proximal end and a distal end. The proximal end is configured with a coupling for connection with a reciprocating shaft 32 of a reciprocating saw 30. In the embodiment shown, the reciprocating saw 30 is a tool, commonly called a Sawzall tool.

The coupling includes a projection 12 and an interface hole 14. The projection is received in a quick release or a manual coupling 34 at the end of the reciprocating shaft 32 of the reciprocating saw. The quick release coupling 34 may be lever activated for selectively positioning a retaining pin (not shown) between a released position and a securement position within the interface aperture 14 of the adapter 10. In a manual coupling, the projection 12 is received in a coupling and the retaining pin is either carried on the reciprocating shaft, for indexing with the reciprocating shaft, or on a clamp coupler that is secured to the reciprocating shaft 32 with a threaded fastener, such as a bolt or a screw.

A pair of saw blades 18 are coupled with the adapter 10 in a parallel orientation at a desired lateral spacing. The pair of saw blades 18 may be coupled to the adapter 10 via one or more mounting points 16 at a distal end of the adapter 10. In the embodiment shown the one or more mounting points 16 are apertures dimensioned to receive a fastener to secure the pair of blades 18 to the adapter 10.

In the embodiment shown, the pair of blades 18 may be made of a conventional reciprocating saw blade with the addition of a second hole 20 spaced apart from the saw interface hole 14 of the blade 18. In this embodiment, the pair of blades 18 are coupled with the adapter 10 via a threaded fastener, such as a bolt 22, or a stud 28, and cooperating nuts 24. One or more washers 26 or spacers may be interposed between the nuts 24 to obtain the desired lateral spacing between the pair of blades 18.

Using my adapter 10 with the pair of saw blades 18, the installer can easily lock on two reciprocating blades spaced apart to the desired width of the slot, the saw cuts a gap in the wall more consistently and twice as fast than making two individual cuts with a single bladed reciprocating saw 30 currently available.

Also with only one blade 18 installed on one side of the adapter 10, the blade 18 may be utilized in at an offset from a reciprocating axis of the reciprocating shaft 32. In this configuration the blade of the present invention provides flush cutting ability without bending the longer blades as typically done in the field, such as when cutting flush to an inside corner of a structure. Accordingly, the invention may also include an adapter 10 configured to carry at least one blade 18 in an offset relation to the reciprocating axis of the reciprocating saw 30 to which it is mounted.

It should be understood, of course, that the foregoing relates to exemplary embodiments of the invention and that modifications may be made without departing from the spirit and scope of the invention as set forth in the following claims.

1. A saw blade assembly for a reciprocating saw, comprising:
an adapter having two parallel planar surfaces with a proximal end and a distal end, having a first shoulder and a second shoulder formed adjacent to the proximal end, the first shoulder being a mirror image of the second shoulder,
a coupling at the proximal end dimensioned to couple the adapter to a reciprocating shaft of the reciprocating saw; and
a pair of saw blades operatively attached to the adapter in a desired lateral spacing from a reciprocating axis of the reciprocating shaft, the pair of saw blades configured for cutting a slot in a substrate, the slot having a width corresponding with the desired lateral spacing.

2. The saw blade assembly of claim 1, wherein the pair of saw blades are adjustably attached to the adapter for selecting the desired lateral spacing.

3. The saw blade assembly of claim 2, wherein the pair of saw blades are disposed on opposed sides of the adapter.

4. The saw blade assembly of claim 3, the coupling further comprising:
a projection extending from the proximal end of the adapter; and
an interface hole adapted to engage with a retaining pin of the reciprocating saw.

5. The saw blade assembly of claim 1, further comprising:
a first aperture and a second aperture defined in a spaced apart relation along the distal end of the adapter;
a first hole defined at a shank of the pair of saw blades;
a second hole defined at an intermediate position of each of the pair of saw blades; and
a first threaded fastener extending through the first aperture and the first hole;
a second threaded fastener extending through the second aperture and the second hole; and
a nut to secure with each of the first threaded fastener and the second threaded fastener to retain the pair of saw blades with the adapter.

6. The saw blade assembly of claim 5, further comprising:
a washer interposed on each of the first threaded fastener and the second threaded fastener to adjust the pair of saw blades at the desired lateral spacing.

7. A reciprocating saw, comprising:
a reciprocating shaft;
an adapter removably coupled with the reciprocating shaft, the adapter having two parallel planar surfaces with a first shoulder and a second shoulder formed adjacent to an end proximal to the reciprocating shaft, the first shoulder being a mirror image of the second shoulder; and
a pair of saw blades operatively attached to the adapter in a desired lateral spacing, the pair of saw blades configured for cutting a slot in a substrate, the slot having a width corresponding with desired lateral spacing.

8. The reciprocating saw of claim 7, wherein the pair of saw blades are adjustably coupled to the adapter.

9. The reciprocating saw of claim 8, wherein the pair of saw blades are adjustably coupled to opposed sides of the adapter.

10. A saw blade assembly for a reciprocating saw, comprising:
an adapter having two parallel planar surfaces with a proximal end and a distal end, with a first shoulder and a second shoulder formed adjacent to the proximal end, the first shoulder being a mirror image of the second shoulder,
a coupling at the proximal end dimensioned to couple the adapter to a reciprocating shaft of the reciprocating saw; and
at least one saw blade operatively attached to the distal end of the adapter at a lateral offset dimension from a reciprocating axis of the reciprocating shaft.

11. The saw blade assembly of claim 10, wherein the at least one saw blade is adjustably attached to the adapter for a selectable lateral offset dimension.

12. The saw blade assembly of claim 10, wherein the adapter has smooth edges and a plurality of apertures spaced along a longitudinal axis, wherein the coupling comprises a tang that is offset from the longitudinal axis, and the distal end is substantially rectangular.
